(19) United States
(12) Patent Application Publication
(10) Pub. No.: US 2025/0071451 A1
(43) Pub. Date: Feb. 27, 2025

(54) METHOD FOR VALIDATING AN AS-BUILT FTTH NETWORK

(71) Applicant: AL TICE LABS, S.A, Aveiro (PT)

(72) Inventors: João Tiago RODRIGUES DOS SANTOS GUERRINHA, Aveiro (PT); Ricardo Nuno VICENTE CADIME, Aveiro (PT); Pedro Antero NUNES DE SOUSA PIRES CARVALHIDO, Aveiro (PT); Tiago SILVA VIEIRA, Aveiro (PT)

(21) Appl. No.: 18/724,554

(22) PCT Filed: Nov. 25, 2022
(86) PCT No.: PCT/IB2022/061415

§ 371 Date: Jun. 26, 2024

(30) Foreign Application Priority Data
Dec. 28, 2021 (PT) 117696

(51) Int. Cl. H04Q 11/00; H04L 41/0806

(52) U.S. Cl. CPC H04Q 11/0067; H04L 41/0806

(57) ABSTRACT

The present invention provides new method to be used to validate the as-built of FTTH projects, based on the end-to-end inventory information and FTTH/GPON rules applied to ODP(s), to declare them “ready for service”. The method assures end-to-end (ISP and OSP) inventory consistency and FTTH/GPON rules conformance. Additionally, it allows the inventory of FTTH projects to be partially approved, the network operator may put on service parts of the project, as long as the network is being deployed and start selling FTTH services earlier. This method presents a new as-built validation paradigm, that verifies the readiness of service each ODP of an FTTH project, guaranteeing, the end-to-end fibre connectivity between the ODP and the OLT(s) located at the CO, the split ratio of each ODP access port follows the configured value (typically 1:64), and the estimated optical budget of each ODP access port is conformant to GPON attenuation standards.

### FIELD OF THE INVENTION

The present invention is enclosed in the field of network communications. Mainly, the present invention relates to methods for validating the as-built of FTTH (Fibre To The Home) projects for inventory readiness for service.

### PRIOR ART

FTTH (Fibre To The Home) is a point-to-multipoint PON (Passive Optical Network) based network that connects by fibre the customer premises to the active equipment located at CO (Central Office), the OLT (Optical Line Termination). The FTTH PON is formed by the CO, the feeder network, and distribution networks. Typically, a 1:64 split ratio is used, with the first stage of splitting located at CO (1:2 splitter), and the second stage at the entrance of the distribution network (1:32 splitter), although other network design strategies may be used.

FTTH is being deployed across the world as a standard network architecture to deliver ultra-broadband services to end-users. The FTTH PON can support GPON (1.25 Gbit/s upstream, 2.5 Gbits/s downstream), XGS-PON (10 Gbit/s upstream, 10 Gbit/s downstream), or both simultaneously.

FTTH rollouts are complex projects with the main objective in mind: deliver ready-for-service HPs (Home Passed) at controlled costs. A fibre rollout project starts after a marketing analysis to define the service areas to be addressed. First, an HLP (high-level planning) is made to have a cost forecast for a GO/NOGO decision. The next step is the LLP (low-level planning), here a detailed network design of ISP (inside plant), OSP (outside plant), and building network is done. The outputs of the LLD phase (list of materials, georeferenced network schematics, connectivity tables, etc) are used for network construction, the phase where the network is built. Finally, auditing the construction, updating the network inventory (as-built activity), doing the handover to network operations, and declaring the project HPs “ready for service”.

At the end of this process is important to have an accurate network inventory to support service eligibility, service provisioning, and service assurance processes. The way the as-built of an FTTH project is implemented and validated is a key point to assure the end-to-end coherence of the inventory.

Today, network operators mostly handle the ISP and OSP activities as verticals, sometimes they also have different inventory OSS for each domain, which means planning, construction, and as-built are implemented and validated separately for ISP and OSP. The lack of integration may lead at the end to inventory inconsistencies and difficulties to accomplish some FTTH/GPON end-to-end rules, like the optical budget for each optical distribution point (ODP) access port.

### Problem to be Solved

FTTH rollouts are complex projects that include planning, construction, auditing, and as-built to update the network inventory with the modifications done in the field. At the end of this process, the HPs belonging to a project are declared “ready for service” and the service provider may start selling services.

Today, network operators usually deal with ISP and OSP separately, and sometimes they have different inventory information systems for each domain. The as-built is done and validated separately for ISP and OSP, this lack of integration may lead to inventory inconsistencies, failures in FTTH/GPON end-to-end rules, and may cause future problems in service eligibility, service provisioning, and service assurance processes.

### SUMMARY OF THE INVENTION

It is therefore the object of the present invention to provide a method for validating the as-built of FTTH projects for inventory readiness for service.

This invention presents a new method to be used to validate the as-built of FTTH projects, based on the end-to-end inventory information and FTTH/GPON rules applied to ODP(s), to declare them “ready for service”. The method assures end-to-end (ISP and OSP) inventory consistency and FTTH/GPON rules conformance.

The method consists of guaranteeing the readiness for service of each ODP of an FTTH project, according: there is end-to-end fibre connectivity between the ODP and the OLT(s) located at the CO; the split ratio of each ODP access port follows the configured value (typically 1:64) the estimated optical budget of each ODP access port is conformant to GPON attenuation standards.

The method here described applies to scenarios where integrated ISP and OSP inventory databases exist.

The method is flexible, allowing partial approval of FTTH projects. As the ready for service is validated per ODP, the network operator may put on service parts of the project, as long as the network is being deployed. This is very important because is not necessary to have all FTTH projects finished in the field to start selling and operating the installed network.

### DESCRIPTION OF FIGURES

FIG. 1 illustrates a diagram representing the typical connectivity FTTH scenario.

### DETAILED DESCRIPTION

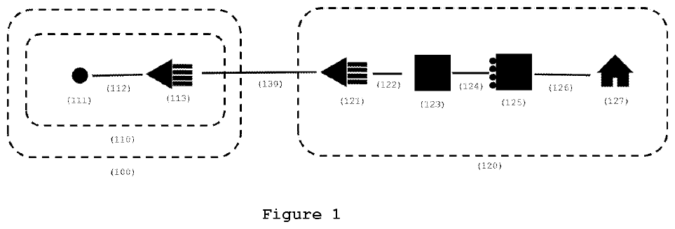

FIG. 1 shows a typical FTTH network comprising the ISP (100) and the OSP (120). The CO (110) is part of ISP, where is included the OLT (111), the Optical Distribution Frame (ODF) (113) as well the patch-cord (112) between them. The OSP is composed by the all the elements outside the CO, including OSJ (121), OS (Optical Splice) (123), ODP (125), the cables that interconnect them (122 and 124), that connect to ISP (130) and the cable (126) that connect to customer premises (127). The ODF, OSJ, and ODP may contain splitters.

The readiness for service for each ODP is guaranteed by the method presented in this disclosure.

These pre-requirements must be ensured to begin the iterative method for validating the as-built of the FTTH projects for inventory readiness for service:
The ODP must be assigned to supply at least one customer premises. This assignment is done while planning the network at the LLD phase.
The ODP must have its address defined, to know where it will be installed.

The method traverses all the elements (equipment, cables, ports, . . . ) in the path between ODP and OLT. In each element, a set of rules should be satisfied to proceed.

The set of equipment rules is:
The equipment must have at least a cable in the OLT direction except when the equipment is the OLT.
The equipment must have ports.
The equipment type must be one of the following: OLT, ODF, OSJ, OS, or ODP.
The equipment must be at Planned or Installed status.

The set of port rules is:
The port must be in an equipment (adapter port) or a splitter (splitter port).
The port must be connected to a fibre or patch-cord.
The port must be optical.
The physical interface of the OLT port must be defined (B/C classes).
The port must be at Planned or Installed status.

The set of cable rules is:
The cable must include optical fibre(s).
The cable must be at Planned or Installed status.

While traversing the path the splitting ratio and the cumulative attenuation are calculated.

The splitting ratio is calculated using the following formula:

$${\prod }_{i = 1}^{n} \frac{1}{{r}_{i}} ,$$

where r is the ratio of each splitter across the path.

This ratio must be the one supported by the network, typically is 1:64 or 1:128.

The attenuation is calculated according to the formula:

$$\sum splitterAtt + \sum portAtt + \sum spliceAtt + AttPatchCords \times \sum patchCordsLength + AttCables \times \sum cablesLength ,$$

where,
splitterAtt is the individual attenuation in a splitter,
portAtt is the individual attenuation in a port, depending on the connector type,
spliceAtt is the individual attenuation in a splice,
attPatchCords is the attenuation in patch cord by the unit of measure and
attCables is the attenuation in cables by the unit of measure.

Typically, in a GPON network with an SFP B+ on the OLT, the attenuation should between 20 db and 28 db.

With this method, the provider ensures services may be provisioned with a low probability of failure due to design problems. Also, since the method can be run on an ODP basis, the service provider can start earlier selling their services.

Since the outputs of this method (based on the previous formulas) are precise values, after the construction phase the measured values should be near the given ones. If not, that means that construction may have problems and may be fixed in an earlier stage, reducing the costs of designing and construction.

### Description of the Embodiments

The following description is presented to enable any person skilled in the art to build and use the invention. Various modifications to the disclosed embodiments will be readily apparent to those skilled in the art. The general principles defined herein may be applied to other embodiments and applications without departing from the scope of the present invention. Thus, the present invention is not intended to be limited to the embodiments shown.

In one embodiment of the invention, a method for validating the as-built of the FTTH projects for inventory readiness for service, namely the end-to-end connectivity between the OLT and the ODP.

The method is used to perform end-to-end connectivity that covers the ISP and OSP transversally.

The method assumes that exists at least one OLT, one ODF, and one ODP. The OSJ and OS are optional, however, all of these equipment must be connected.

The method involves calculating the splitting ratio of the path between the OLT and ODP:

$${\prod }_{i = 1}^{n} \frac{1}{{r}_{i}}$$

Where r is the ratio of each splitter across the path.

The method also involves calculating the attenuation of the same path:

$$\sum splitterAtt + \sum portAtt + \sum spliceAtt + AttPatchCords \times \sum patchCordsLength + AttCables \times \sum cablesLength$$

Where splitterAtt is the individual attenuation in a splitter, portAtt is the individual attenuation in a port, depending on the connector type, spliceAtt is the individual attenuation in a splice, attPatchCords is the attenuation in patch cord by the unit of measure and attCables is the attenuation in cables by the unit of measure.

1. Method for validating an as-built FTTH network having at least one Optical Line Termination (OLT), one Optical Distribution Frame (ODF) and one Optical Distribution Point (ODP), comprising steps:
i. Validation of pre-requirements of the FTTH network;
ii. Once the pre-requirements are validated, a set of verification rules is applied to each network element in a path between the ODP and the OLT;
iii. If the set of verification rules is complied by all network elements, a splitting ratio and a cumulative attenuation of the network are monitored periodically.

2. The method according to claim 1, wherein the pre-requirements relate to:
ODP's assignment to supply at least one customer premises, and
ODP's address that must be defined.

3. The method according to claim 1, wherein a network element may be of at least three types: equipment, port or cable;
and wherein,
a set of verification rules is applied to each network element type.

4. The method according to claim 3, wherein the set of verification rules of an equipment-type element includes criteria:
The equipment has at least a cable in the OLT direction except when the equipment is the OLT;
The equipment has ports;
The equipment type is one of a following: OLT, ODF, OSJ, OS, or ODP; and
The equipment is at Planned or Installed status.

5. The method according to claim 3, wherein the set of verification rules of a port-type element, includes criteria:
The port is in an equipment or a splitter;
The port is connected to a fibre or patch-cord;
The port is optical;
A physical interface of the OLT port is defined as class B or class C;
The port is at Planned or Installed status.

6. The method according to claim 2, wherein the set of verification rules of a cable-type element, includes criteria:
The cable includes at least on optical fibre;
The cable is at Planned or Installed status.

7. The method according to claim 1, wherein the splitting ratio is determined according to formula:
$${\prod }_{i = 1}^{n} \frac{1}{{r}_{i}}$$
wherein,
r is the ratio of each splitter across the path,
n is a number of splitters across the path.

8. The method according to claim 7, wherein the cumulative attenuation is determined according to formula:
$$\sum splitterAtt + \sum portAtt + AttPatchCords \times \sum patchCordsLength + AttCables \times \sum cablesLength ,$$
wherein,
splitterAtt is a individual attenuation in a splitter;
portAtt is the individual attenuation in a port, depending on a connector type;
spliceAtt is the individual attenuation in a splice;
attPatchCords is the attenuation in patch cord by a unit of measure; and
attCables is the attenuation in cables by a unit of measure.

9. The method according to claim 8, wherein the cumulative attenuation is within a range of 20 db to 28 db.
